(19) United States
(12) Patent Application Publication
(10) Pub. No.: US 2026/0332536 A1
(43) Pub. Date: Oct. 22, 2026

(54) HIGH-SPEED PRIORITY QUEUE MANAGEMENT APPARATUS AND METHOD CAPABLE OF PER-NODE DELAY CONTROL IN COMMUNICATION SYSTEM

(71) Applicant: ELECTRONICS AND TELECOMMUNICATIONS RESEARCH INSTITUTE, Daejeon (KR)

(72) Inventors: Chang-Ho CHOI, Daejeon (KR); Yeon-Cheol RYOO, Daejeon (KR); Tae-Sik CHEUNG, Daejeon (KR)

(73) Assignee: ELECTRONICS AND TELECOMMUNICATIONS RESEARCH INSTITUTE, Daejeon (KR)

(21) Appl. No.: 19/468,821

(22) Filed: Feb. 3, 2026

(30) Foreign Application Priority Data
Feb. 10, 2025 (KR) 10-2025-0016677

(51) Int. Cl. H04L 47/56; H04L 47/2425; H04L 49/90; H04L 49/901; H04L 49/9057

(52) U.S. Cl. CPC H04L 47/56; H04L 47/2425; H04L 49/901; H04L 49/9042; H04L 49/9057

(57) ABSTRACT

A high-speed priority queue management method capable of per-node delay control includes receiving packets and determining output times of the packets, dividing each packet into one or more packet segments according to memory segment size, receiving allocation of a number of free pointers corresponding to a number of packet segments from packet buffer free pointer FIFO, and storing the packet segments in a packet buffer, receiving allocation of free pointers from a metadata buffer free pointer FIFO, and storing, in a priority queue metadata buffer, metadata including a number of memory segments, a packet length, and a memory segment pointer, storing output times of the packets and pointers of a metadata buffer in a binary heap-based priority queue, and sorting the pointers in order of output times, and when system time exceeds an output time stored at a top entry of the priority queue, outputting the corresponding packet.

### CROSS REFERENCE TO RELATED APPLICATION

This application claims the benefit of Korean Patent Application No. 10-2025-0016677, filed Feb. 10, 2025, which is hereby incorporated by reference in its entirety into this application.

### BACKGROUND OF THE INVENTION

### 1. Technical Field

The present disclosure relates to priority queue management in a communication system. More particularly, the present disclosure relates to a technology for controlling delay times for respective nodes and managing a priority queue at high speed in a communication system.

### 2. Description of the Related Art

An on-time Quality of Service (QoS) guarantee technology aims to ensure that data transferred over a packet network is delivered to a destination so as to satisfy user requirements (delay or delay variation). For this, there are required a packet processing technology that determines a per-packet output time so as to satisfy user requirements for specialized services that need to minimize delay and guarantee QoS, and a queue management technology that controls packet input and output based on the output times.

A priority queue scheme is a method in which input packets are preferentially output according to the priorities of the input packets, and is characterized in that, when an output order is changed according to the priorities, a buffer that stores the packets needs to be managed to support the changed output order. As schemes for implementing a priority queue, there are a scheme that uses multiple First-In, First-Out (FIFO) devices, a scheme that uses a time-slot-based calendar queue, a scheme that uses a binary heap, and the like.

Similar to the priority queue, a Push-In First-Out (PIFO) queue scheme is a scheduling algorithm in which packets are stored at positions corresponding to priorities when they are enqueued, and a packet with a highest priority is dequeued first. As a scheme for implementing a PIFO queue, a binary heap is generally used, but, during the input (enqueue) and output (dequeue) of packets, a sorted state of the queue needs to be consistently maintained, and system implementation is complicated when packets are to be processed at high speed. Accordingly, an approximate PIFO implementation scheme such as for optimization of memory use has been proposed.

A packet buffer using a linked list divides an input packet into units of memory segments, and is then assigned free pointers for respective segments to store the free pointers. Here, when a single packet is divided into multiple segments, the multiple segments belonging to the single packet are linked to each other by addresses of subsequent segments up to a last segment in such a way that a first segment includes the address of a second segment subsequent thereto and the second segment includes the address of a third segment.

### SUMMARY OF THE INVENTION

Accordingly, the present disclosure has been made keeping in mind the above problems occurring in the prior art, and an object of the present disclosure is to provide an apparatus and method for providing a high-precision end-to-end on-time service by controlling packet output times for respective nodes in a communication system.

Another object of the present disclosure is to provide an apparatus and method for accurately outputting packets at determined output times through a binary-heap-based sorted priority queue and efficient free pointer management of a packet buffer in a communication system.

A further object of the present disclosure is to provide an apparatus and method for efficiently storing and managing packet segments in a communication system.

Yet another object of the present disclosure is to provide an apparatus and method for processing packets at high speed using metadata in a communication system.

Still another object of the present disclosure is to provide an apparatus and method

for efficiently processing variable-length packets in a communication system.

Still another object of the present disclosure is to provide an apparatus and method for decreasing complexity of priority queue management in a communication system.

In accordance with an aspect of the present disclosure to accomplish the above objects, there is provided a high-speed priority queue management method capable of per-node delay control, including receiving packets and determining output times of the packets based on node budget profiles, dividing each packet into one or more packet segments according to a memory segment size, receiving an allocation of a number of free pointers corresponding to a number of packet segments from a packet buffer free pointer First-In First-Out (FIFO), and storing the packet segments in a packet buffer, receiving an allocation of free pointers from a metadata buffer free pointer FIFO, and storing, in a priority queue metadata buffer, metadata including a number of memory segments for the corresponding packet, a packet length, and a memory segment pointer, storing output times of the packets and pointers of a metadata buffer in which the metadata is stored in a binary heap-based priority queue, and sorting the pointers in order of the output times, and when a system time exceeds an output time stored at a top entry of the priority queue, outputting the corresponding packet.

In accordance with another aspect of the present disclosure to accomplish the above objects, there is provided a high-speed priority queue management apparatus capable of per-node delay control, including an input port configured to receive packets, a packet processor configured to determine output times of the packets, a packet buffer configured to store each packet in units of memory segments, a packet buffer free pointer First-In First-Out (FIFO) configured to manage pointers of available memory segments, a priority queue metadata buffer configured to store metadata of the packets, a metadata buffer free pointer FIFO configured to manage available metadata buffer pointers, a binary heap-based priority queue configured to store the output times of the packets and metadata buffer pointers and perform sorting in an order of output times, a time synchronizer configured to provide system time information, a node budget profile configured to manage delay time information used to determine the output times of the respective packets, and an output port configured to output the packets.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 illustrates a communication network composed of a source, a destination, and nodes for connecting the source and the destination according to an embodiment of the present disclosure;

FIG. 2 is a functional block diagram of each node constituting a high-speed communication network capable of delay control according to an embodiment of the present disclosure;

FIG. 3 is a detailed block diagram of a packet buffer manager block according to an embodiment of the present disclosure;

FIG. 4 is a detailed block diagram of a priority queue manager block according to an embodiment of the present disclosure;

FIG. 5 illustrates an example of a node budget profile block 600;

FIG. 6 illustrates a packet reception and transmission processing process according to an embodiment of the present disclosure;

FIGS. 7A to 7D illustrate an operating process of a packet buffer block with reference to the processing sequence of FIG. 6 according to an embodiment of the present disclosure;

FIGS. 8A and 8B illustrate an operating process of a packet buffer free pointer First-In First-Out (FIFO) block with reference to the processing sequence of FIG. 6 according to an embodiment of the present disclosure;

FIG. 9 illustrates an operating process of a priority queue metadata buffer block with reference to the processing sequence of FIG. 6 according to an embodiment of the present disclosure;

FIGS. 10A and 10B illustrate an example of an operating process of a metadata buffer free pointer FIFO block according to the present disclosure;

FIGS. 11A to 11C illustrate a detailed configuration of metadata for each packet;

FIGS. 12A to 12C illustrate an example of an operating process of a priority queue

block 800 according to an embodiment of the present disclosure;

FIG. 13 illustrates an example of connection states between the priority queue block 800, a priority queue metadata buffer block 510, and a packet buffer block 200 according to an embodiment of the present disclosure;

FIG. 14 illustrates an example of a packet enqueue process according to the present disclosure;

FIG. 15 illustrates an example of a packet dequeue process according to the present disclosure; and

FIG. 16 illustrates the configuration of a high-speed priority queue management apparatus capable of per-node delay control according to an embodiment of the present disclosure.

### DESCRIPTION OF THE PREFERRED EMBODIMENTS

The terms used in the present disclosure are merely intended to describe specific embodiments, and are not intended to limit the scope of other embodiments. Unless the context clearly indicates otherwise, a singular form includes a plural form. The terms used herein, including technical or scientific terms, may have the same meanings as those generally understood by those skilled in the art to which the present disclosure pertains. Among the terms used in the present disclosure, terms defined in a general dictionary may be construed as having the same or similar meanings as those understood in the context of the related art, and, unless explicitly defined in the present disclosure, are not to be construed in an idealized or overly formal sense. In some cases, even terms defined in the present disclosure should not be construed so as to exclude the embodiments of the present disclosure.

In various embodiments of the present disclosure, which will be described below, hardware-based approaches will be described by way of example. However, since various embodiments of the present disclosure include technologies that use both hardware and software, the various embodiments of the present disclosure do not exclude software-based approaches.

Furthermore, in the detailed description and claims of the present disclosure, the phrase “at least one of A, B, and C” may mean “only A,” “only B,” “only C,” or “any combination of A, B, and C.” Also, the phrase “at least one of A, B, or C” or “at least one of A, B, and/or C” may mean “at least one of A, B, and C”.

Hereinafter, the present disclosure relates to a high-speed priority queue management apparatus and method capable of per-node delay control in a communication system. Specifically, the present disclosure describes a technology for managing a priority queue enabling high-speed processing by controlling per-node delay to satisfy precise user requirements for delay between terminals in a communication system, and by efficiently managing a sorted priority queue based on a binary heap and a packet buffer configured as a linked list.

Terms used in the following description, including terms referring to signals, channels, control information, network entities, and components of an apparatus, are illustrated by way of example for convenience of description. Accordingly, the present disclosure is not limited to the terms, which will be described later, and other terms having equivalent technical meanings may be used.

In addition, although the present disclosure describes various embodiments using terms employed in some communication standards (e.g., 3rd Generation Partnership Project: 3GPP), these embodiments are only examples for description. Various embodiments of the present disclosure may also be easily modified and applied to other communication systems.

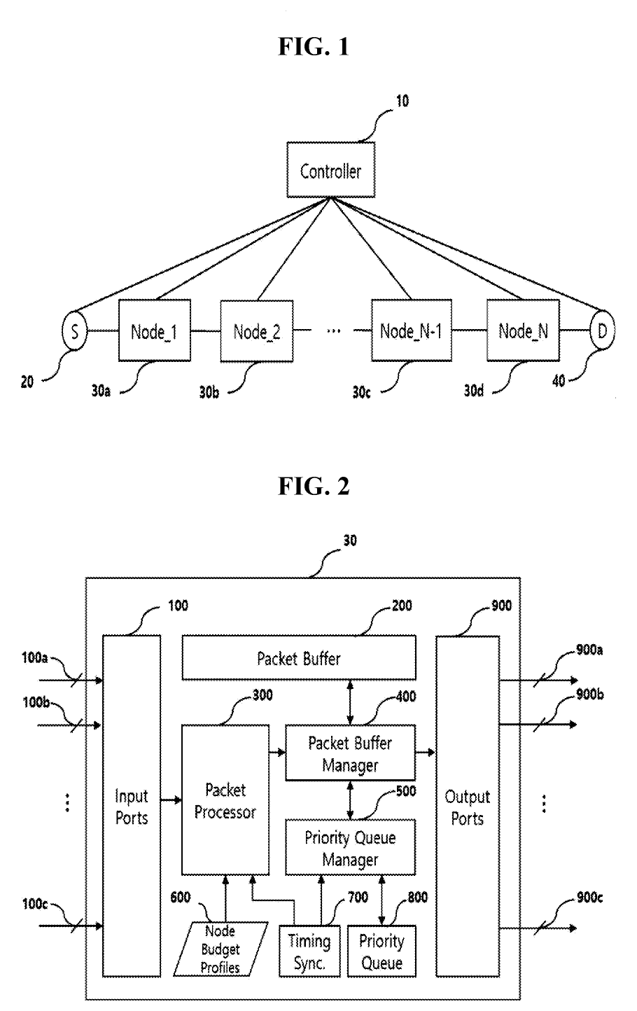

FIG. 1 illustrates a communication network composed of a source, a destination, and nodes for connecting the source and the destination according to an embodiment of the present disclosure.

Referring to FIG. 1, the communication network may include a source terminal (S) 20 which transmits data, a destination terminal (D) 40 which receives data, multiple nodes (Node_1 to Node_N) 30a to 30d which transfer data therebetween, and a controller 10 which controls the entire network.

The controller 10 is positioned at an upper level and is directly connected to all nodes, and performs functions such as network configuration and management, control of operations of respective nodes, and setting of data transmission paths. The data originates from the source terminal (S) 20 and is transferred to the nodes in the order of Node_1 30a, Node_2 30b, ..., Node_N-1 30c, and Node_N 30d, and finally reaches the destination terminal (D) 40.

Each node may perform tasks such as data processing, priority adjustment, and delay control during a data transfer process. In particular, the present disclosure may satisfy various QoS requirements by controlling delay through efficient priority queue management at each node.

FIG. 2 is a functional block diagram of each node constituting a high-speed communication network capable of delay control according to an embodiment of the present disclosure.

Referring to FIG. 2, each node 30 constituting the communication network may include an input port block (input ports) 100 for receiving packets through one or more physical interfaces 100a to 100c.

Further, each node 30 may include a packet processor block 300 configured to perform various packet processing procedures and to include a process of determining, for respective packets, output times in order to transfer received packets to a next destination; a packet buffer manager block 400 and a packet buffer block 200 configured to store the received packets during the packet processing procedures and to output the packets after packet processing is completed; a priority queue manager block 500 and a priority queue block 800 configured to schedule an output order and output times of the received packets according to various priorities; a time synchronizer block 700 configured to provide system time information to the packet processor block 300 and the priority queue manager block 500; a node budget profile block (node budget profiles) 600 configured to manage delay information used in the process of determining the output times for respective packets in the packet processor block 300; and an output port block (output ports) 900 configured to transmit the received packets through one or more physical interfaces 900a to 900c.

The input port block 100 may be composed of one or more physical interfaces 100a to 100c, and may transfer packets received through the above-described physical interfaces 100a to 100c to a subsequent packet processor block 300.

The packet processor block 300 may receive packets from the input port block 100, classify the packets based on defined rules, and may determine output ports to transfer the packets to next destinations. If necessary, procedures such as filtering, policing, and shaping may be additionally performed. Further, according to priority policies, the priorities of the packets may be designated based on various criteria.

The packet buffer block 200 may perform a function of storing the packets received through the input port block 100 in multiple memories until the received packets are transmitted to the output port block 900.

Each of the above-described memories may be divided into memory segments, each having a certain size, and the memory segments may be interconnected with each other by pointers (addresses), thus storing not only packets having a fixed length but also packets having a variable length. Here, the sizes of the memory segments may be set to various sizes such as 64B, 128B, 256B, and 512B according to configuration.

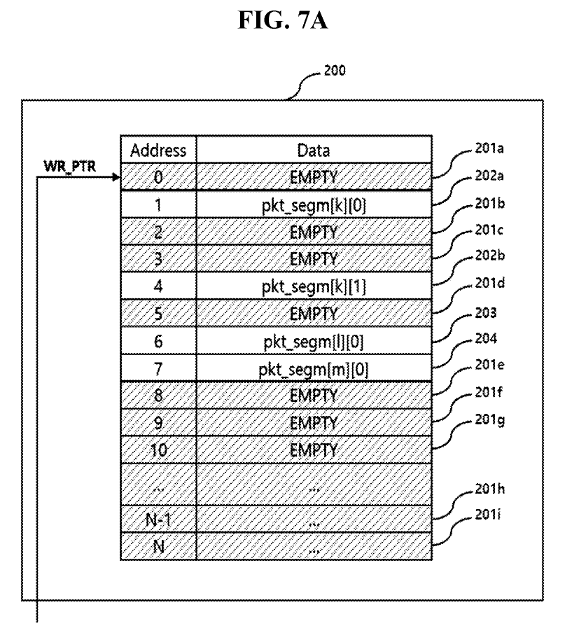

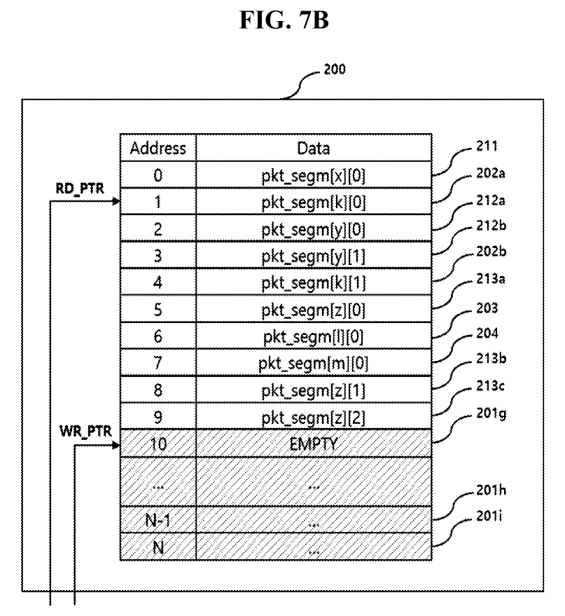

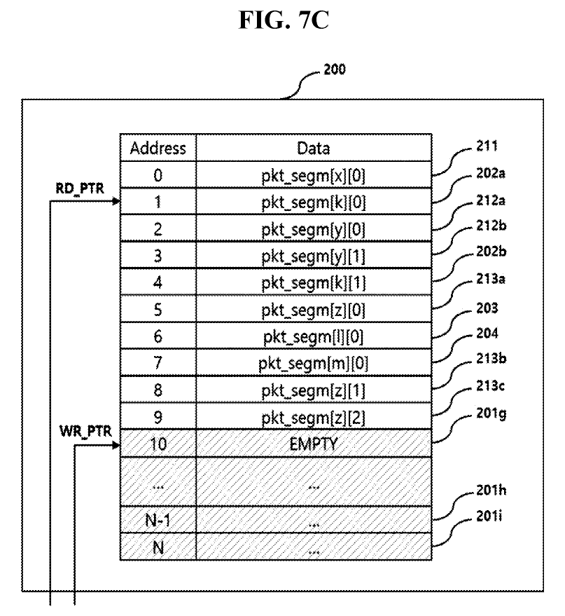

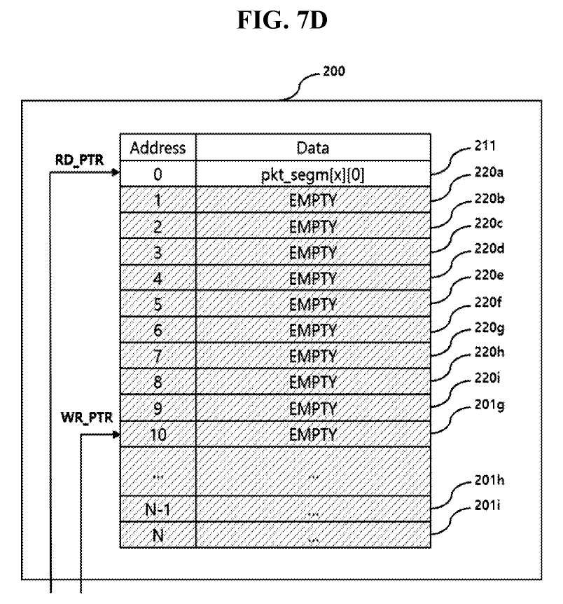

Further, the above-described received packets may be stored in a specific memory region or discarded (i.e., dropped) based on the results of packet processing by the packet processor block 300, and the output times of the packets from respective nodes may be controlled such that the packets reach destinations at desired times in response to user requirements. A process of storing and outputting the packets in association with the packet buffer manager block 400 will be described in detail later with reference to FIG. 7.

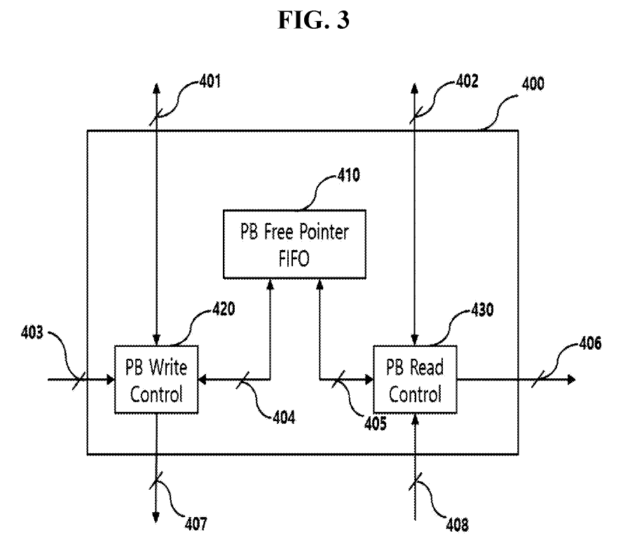

The packet buffer manager block 400 may be connected to the packet processor block 300, the packet buffer block 200, the priority queue manager block 500, and the output port block 900. The packet buffer manager block 400 may allocate the address of a memory segment that is empty without being used so as to store the received packets in the packet buffer block 200, and may return the memory segment address to recycle memory resources when the output of the stored packets from the packet buffer block 200 is completed. Also, metadata information of the above-described packets may also be transferred to the priority queue manager block 500 so as to enable fast processing in an output process. A detailed configuration of the packet buffer manager block 400 will be described in detail later with reference to FIG. 3.

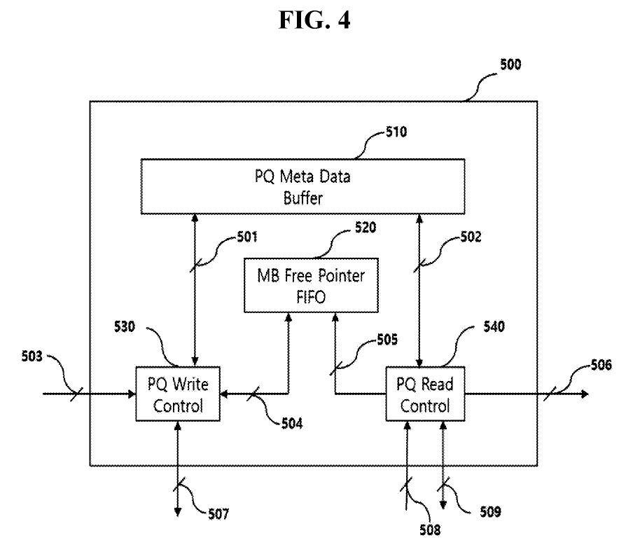

The priority queue manager block 500 may be connected to the packet buffer manager block 400, the time synchronizer block 700, and the priority queue block 800, and may perform enqueue and dequeue processes on the above-described queue block 800 based on the priorities of the received packets. Also, to control the above-described dequeue process, the priority queue manager block 500 may receive system time information from the time synchronizer block 700. A detailed configuration of the priority queue manager block 500 will be described in detail later with reference to FIG. 4.

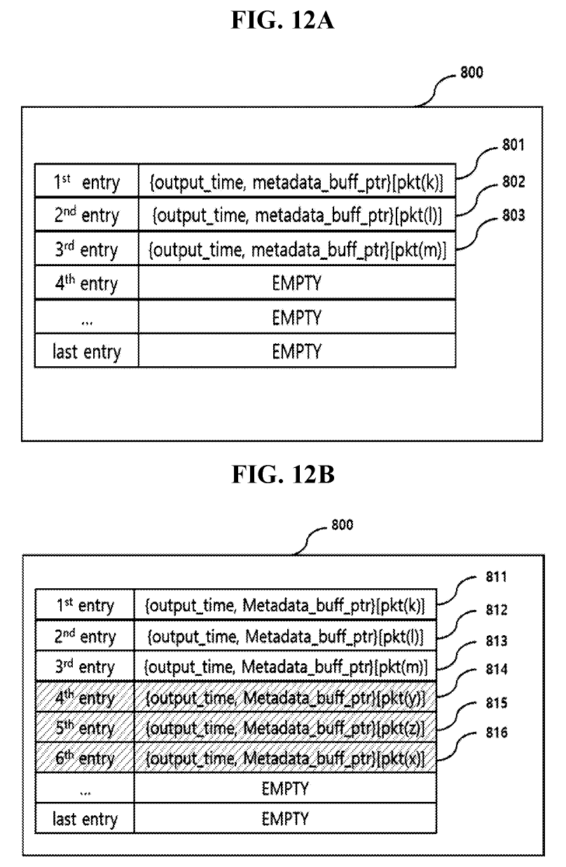

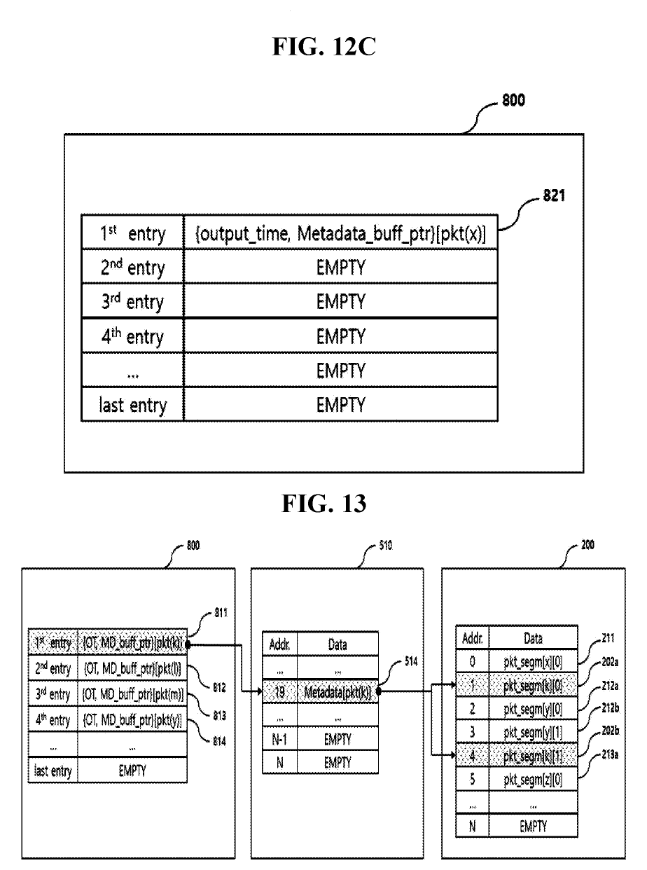

The priority queue block 800 may be configured such that various types of queues are used depending on respective purposes, and may set independent queues, for example, on a per-input port basis, a per-output port basis, a per-class basis or a per-flow basis. In an embodiment of the present disclosure, a binary heap-based sorted priority queue scheme may be used such that, for each output port, a packet having the earliest output time is output first. The priority queue block 800 will be described in detail later with reference to FIG. 12.

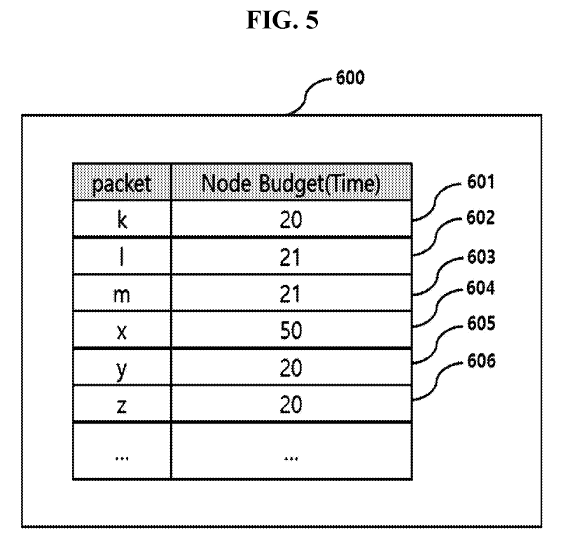

The node budget profile block 600 may include pieces of delay information for respective nodes, which are required to determine the output times of the received packets. The above-described node budget profile block 600 will be described in detail later with reference to FIG. 5.

The time synchronizer block 700 may perform a clock synchronization function generally required in each node, and may perform a time synchronization function of providing the same time information between all terminals and nodes within the network for a specific application. Here, for time synchronization, a high-precision time synchronization protocol, such as IEEE 1588v2, may be used. Further, the time synchronizer block 700 may manage a current time using the synchronized clock or time, and may transfer the above-described current time to the packet processor block 300 and the priority queue manager block 500.

The output port block 900 may be composed of one or more physical interfaces 900a to 900c, and may transfer the packets to next destinations through the physical interfaces 900a to 900c.

FIG. 3 is a detailed block diagram of a packet buffer manager block according to an embodiment of the present disclosure.

Referring to FIG. 3, the packet buffer manager block 400 may be connected to the packet processor block 300, the packet buffer block 200, the priority queue manager block 500, and the output port block 900, respectively, through respective internal interfaces, and may be composed of a packet buffer free pointer First-In First-Out (FIFO) block 410, a packet buffer input (write) control block 420, and a packet buffer output (read) control block 430.

More specifically, the packet buffer manager block 400 is connected to the above-described packet processor block 300 through an internal interface 403, and configured to receive each packet and information related to transfer of the packet including output time thereof, divide the packet into memory segment-sized units and store the divided packet in the packet buffer block 200 through an internal interface 401. The packet buffer manager block 400 may transfer information about the above-described packet, generated at this stage (hereinafter referred to as metadata), such as the number of memory segments, a packet length, and memory segment pointers, together with the output time of the packet, to the priority queue manager block 500 through an internal interface 407.

The packet buffer manager block 400 may receive a packet output request and metadata of the corresponding packet from the priority queue manager block 500 through an internal interface 408, may receive packet segments from the packet buffer block 200 through an internal interface 402 using the metadata, may reassemble the above-described packet segments to form a packet, and may then transfer the packet to the output port block 900 through an internal interface 406.

In accordance with an embodiment, when one or more memory segment pointers are present for a single packet, the memory segment pointers may include a first memory segment pointer (start-of-packet memory segment pointer) sop_ptr and next memory pointers next_ptr[1 to n].

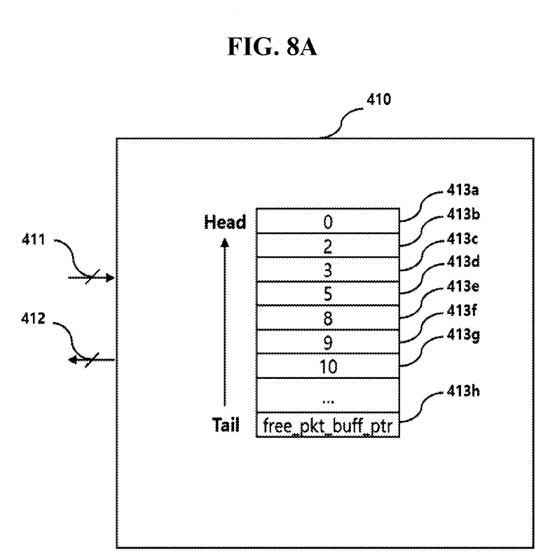

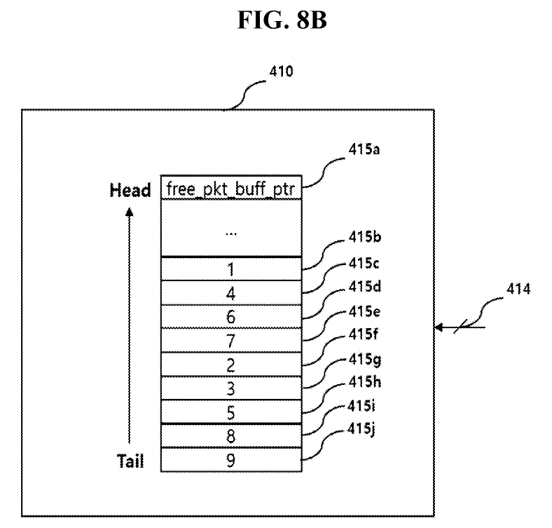

In detail, the packet buffer free pointer FIFO block 410 may perform a function of managing currently available memory segment pointers in the packet buffer block 200. When a pointer request signal is received from the packet buffer write control block 420 through an internal interface 404, an available memory segment pointer may be output from a head of the FIFO. When a recycle request signal, together with the memory segment pointer that has already been used (i.e., output from the packet memory block 200), is received from the packet buffer read control block 430 through an internal interface 405, the memory segment pointer may be stored at a tail of the FIFO. An operating process of the packet buffer free pointer FIFO block 410 will be described in detail later with reference to FIGS. 8A and 8B.

More specifically, the packet buffer write control block 420, after receiving a packet and information related to the packet from the packet processor block 300, may divide the packet into packet segments according to the size of memory segments constituting the packet buffer block 200 so as to store the received packet in the packet buffer block 200, and may request, through the internal interface 404, a number of unused memory segment addresses (hereinafter referred to as packet buffer free pointers) corresponding to the number of divided memory segments from the packet buffer free pointer FIFO block 410, and may receive the packet buffer free pointers. When the packet buffer free pointers are received, the packet segments may be stored in the packet buffer block 200 by using the pointers as addresses. When a single packet is divided into one or more packet segments and stored, metadata including the number of memory segments for the above-described packet and memory segment pointers, together with output time information of the packet, may be transferred to and managed in the priority queue manager block 500 instead of storing a next memory segment pointer in the corresponding packet segment.

In detail, the packet buffer read control block 430 may receive the metadata from the priority queue manager block 500, and may perform a process of outputting the corresponding packet. Here, the number of memory segments of the packet, packet length, and memory segment pointers may be extracted from the metadata, and the packet segments may be output from the packet buffer block 200. When one or more packet segments need to be output for a single packet, packet segments may be successively output using the number of memory segments and the memory segment pointers, which are extracted from the metadata, and may then be finally output through a reassemble process. The memory segment pointers, used when the packet segments are output from the packet buffer block 200, may be transferred for recycling to the packet buffer free pointer FIFO block 410 through the internal interface 405.

The packet buffer manager block 400 may receive a packet output request and metadata of the corresponding packet from the priority queue manager block 500 through the internal interface 408, may receive packet segments from the packet buffer block 200 through the internal interface 402 using the metadata, may reassemble the above-described packet segments to form a packet, and may the transfer the packet to the output port block 900 through the internal interface 406.

FIG. 4 is a detailed block diagram of a priority queue manager block according to an embodiment of the present disclosure.

Referring to FIG. 4, the priority queue manager block 500 may be connected to the packet buffer manager block 400, the time synchronizer block 700, and the priority queue block 800 through respective internal interfaces, and may include a priority queue metadata buffer block 510, a metadata buffer free pointer FIFO block 520, a priority queue input (write) control block 530, and a priority queue output (read) control block 540.

More specifically, the priority queue manager block 500 may be connected to the packet buffer manager block 400 through an internal interface 503 to receive output time and metadata of each received packet, and may store the above-described metadata in the priority queue metadata buffer block 510. Priority queue metadata buffer pointers, which are generated when the output time and the metadata of the packet are stored, may be transferred to the priority queue block 800 through an internal interface 507.

The priority queue manager block 500 may be connected to the time synchronizer block 700 through an internal interface 508 to receive system time information (hereinafter referred to as ‘current time’, which may be local time or globally synchronized time). The priority queue manager block 500 may be connected to the priority queue block 800 through an internal interface 509 to receive a priority queue metadata buffer pointer for a packet having an earliest output time from the first entry of the priority queue block and monitor the priority queue metadata buffer pointer. After the current time exceeds the above-described output time during monitoring, the metadata may be output from the priority queue metadata buffer block 510 using the priority queue metadata buffer pointer, and thus a process of outputting the corresponding packet may be initiated. The metadata may be transferred to the packet buffer manager block 400 through an internal interface 506.

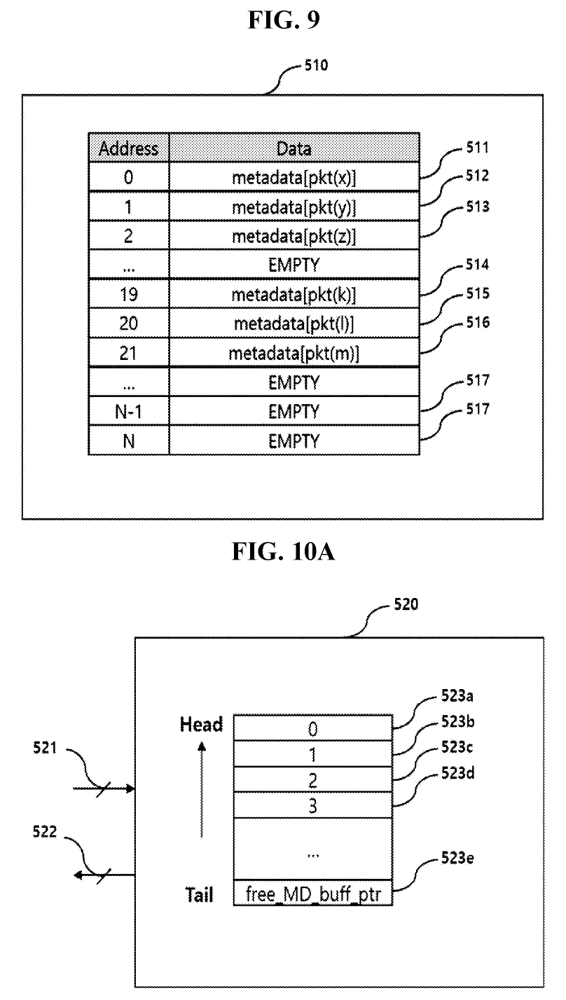

More specifically, the priority queue metadata buffer block 510 may perform a function of storing the metadata transferred from the packet buffer manager block 400, and outputting the stored metadata to the packet buffer manager block 400 according to sorted priorities. The metadata may be stored in accordance with an order in which packets are input, but may be output regardless of the storage order according to the priorities (output times of packets) sorted by the priority queue block 800. An operating process of the priority queue metadata buffer block 510 will be described in detail later with reference to FIG. 9.

More specifically, the metadata buffer free pointer FIFO block 520 may perform a function of managing currently available memory pointers in the priority queue metadata buffer block 510. When a pointer request signal is received from the priority queue write control block 530 through an internal interface 504, an available memory pointer may be output from a head of the FIFO. When a recycle request signal, together with a memory pointer that has already been used (i.e., output from the priority queue metadata buffer block 510), is received from the priority queue read control block 540 through an internal interface 505, the memory pointer may be stored at a tail of the FIFO. An operating process of the metadata buffer free pointer FIFO block 520 will be described in detail later with reference to FIG. 11.

More specifically, the priority queue write control block 530 may receive the output time and metadata of each packet from the packet buffer manager block 400, and may then receive a metadata buffer free pointer by requesting an unused memory address (hereinafter referred to as metadata buffer free pointer) from the metadata buffer free pointer FIFO block 520 through an internal interface 504 so as to store the metadata in the priority queue metadata buffer block 510. When the metadata buffer free pointer is received, the above-described metadata may be stored at an address indicated by the corresponding pointer in the priority queue metadata buffer block 510 through an internal interface 501. Both the output time of the corresponding packet and the metadata buffer free pointer, used to store the metadata in the priority queue metadata buffer block 510, may be transferred to the priority queue block 800.

More specifically, the priority queue read control block 540 may receive a priority queue metadata buffer pointer for a packet having an earliest output time from the first entry of the priority queue block 800 and monitor the priority queue metadata buffer pointer. After the current time exceeds the above-described output time during monitoring, the metadata of the packet may be output from the priority queue metadata buffer block 510 using the priority queue metadata buffer pointer, and may be transferred to the packet buffer manager block 400.

Here, during a period in which the current time does not exceed the output time, the priority queue metadata buffer block 510 may wait without outputting the metadata of the packet. Here, during the period in which the current time does not exceed the above-described output time, there may occur a case in which the first entry of the priority queue block 800 is changed. In this case, the output time of a packet stored in the changed entry, that is, a new entry, is compared with the current time. After the current time exceeds the output time of the new entry, the metadata of the packet may be output from the priority queue metadata buffer block 510, and may be transferred to the packet buffer manager block 400. The priority queue metadata buffer pointer used to output the metadata from the priority queue metadata buffer block 510 may be transferred for recycling to the metadata buffer free pointer FIFO block 520 through the internal interface 505.

FIG. 5 illustrates an example of the node budget profile block 600.

Referring to FIG. 5, assuming that input packets are packet[k], packet[l], packet[m], packet[x], packet[y], and packet[z], it can be seen that delay times (node budgets) designated to determine output times based on times at which respective packets are input in the current node are set to packet[k] 601, packet[l] 602, packet[m] 603, packet[x] 604, packet[y] 605, and packet[z] 606, respectively. Through such a node budget profile block 600, delay times of respective packets may be systematically managed.

When node budgets are set for respective packets, the node budgets may be set individually or in groups on a per-packet basis, a per-flow basis, a per-flow-group basis, or a per-class basis.

In setting node budgets for respective packets, the node budgets may be set to time intervals such as maximum and minimum times in another manner.

In assigning node budgets for respective packets, the node budgets may be set in consideration of link delay, node processing delay, node queuing delay, and the like in a further manner.

In assigning node budgets for respective packets, the node budgets may be set depending on set shaping attributes, or may be set by applying fair queuing in yet another manner.

Alternatively, delay characteristics required by the controller 10 that controls a communication network may be divided according to the resources of the nodes, and may then be respectively set for all nodes of the network. Alternatively, a node budget may be set for a current node by simply dividing accumulated delays by the number of remaining hops to a destination. Alternatively, node budgets may be set for respective nodes in combination of various schemes including the above-described schemes.

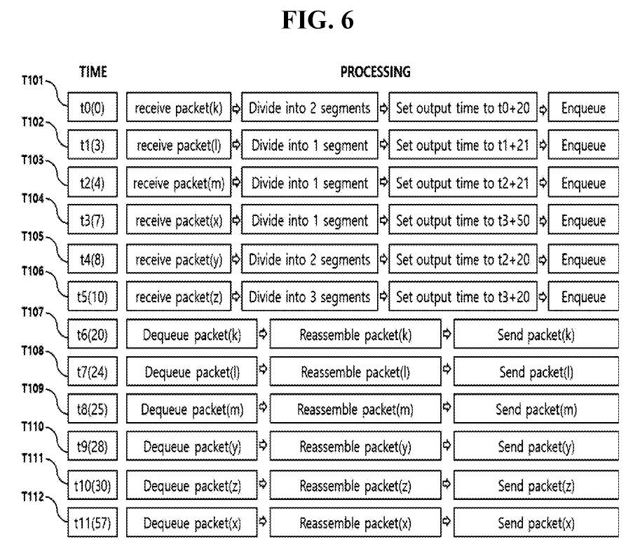

FIG. 6 illustrates a procedure for processing packet reception and transmission according to an embodiment of the present disclosure.

Referring to FIG. 6, assuming that input packets are packet[k], packet[l], packet[m], packet[x], packet[y], and packet[z] and the node budgets of respective packets are set, as shown in FIG. 5, and that the lengths of packets to be divided into packet segments are packet[k][2], packet[l][1], packet[m][1], packet[x][1], packet[y][2], and packet[z][3], respectively, the procedure for processing reception and transmission of each packet will be described as follows.

When t0 starts at time 0 and packet[k] is received, the length of the packet to be divided into packet segments is 2, and thus the packet is divided into two packet segments. Because a node budget set for packet[k] is 20, output time of the packet is determined to bet0(0)+20, that is, 20, after which the packet is enqueued into the priority queue block (T101).

When t1 starts at time 3 and packet[l] is received, the length of the packet to be divided into packet segments is 1, and then the packet is composed of one packet segment. Because a node budget set for packet[l] is 21, output time of the packet is determined to be t1(3)+21, that is, 24, after which the packet is enqueued into the priority queue block (T102).

When t2 starts at time 4 and packet[m] is received, the length of the packet to be divided into packet segments is 1, and then the packet is composed of one packet segment. Because a node budget set for packet[m] is 21, output time of the packet is determined to be t2(4)+21, that is, 25, after which the packet is enqueued into the priority queue block (T103).

When t3 starts at time 7 and packet[x] is received, the length of the packet to be divided into packet segments is 1, and then the packet is composed of one packet segment. Because a node budget set for packet[x] is 50, output time of the packet is determined to be t3(7)+50, that is, 57, after which the packet is enqueued into the priority queue block (T104).

When t4 starts at time 8 and packet[y] is received, the length of the packet to be divided into packet segments is 2, and thus the packet is divided into two packet segments. Because a node budget set for packet[y] is 20, output time of the packet is determined to be t4(8)+20, that is, 28, after which the packet is enqueued into the priority queue block (T105).

When t5 starts at time 10 and packet[z] is received, the length of the packet to be divided into packet segments is 3, and thus the packet is divided into three packet segments. Because a node budget set for packet[z] is 20, output time of the packet is determined to be t5(10)+20, that is, 30, after which the packet is enqueued into the priority queue block (T106).

Since packet[k] has the smallest (earliest) output time among the output times determined for the packets received so far, no packet is output before time 20.

At time 20, t6 starts, packet[k] is dequeued, and two packet segments are reassembled into an original packet, after which the original packet is output (sent) (T107).

Since packet[l] has the smallest output time (earliest output time) after packet[k] is output, t7 starts at time 24, packet[l] is dequeued, and one packet segment is reassembled into an original packet, after which the original packet is output (T108).

Since packet[m] has the smallest output time (earliest output time) after packet[l] is output, t8 starts at time 25, packet[m] is dequeued, and one packet segment is reassembled into an original packet, after which the original packet is output (T109).

Since packet[y] has the smallest output time (earliest output time) after packet[m] is output, packet[x] precedes packet[y] in input order, but, based on the output time, packet[y] precedes packet[x] in output order. Accordingly, t9 starts at time 28, packet[y] is dequeued, and two packet segments are reassembled into an original packet, after which the original packet is output (T110).

Since packet[z] has the smallest output time (earliest output time) after packet[y] is output, packet[x] precedes packet[z] in input order, but, based on the output time, packet[z] precedes packet[x] in output order. Accordingly,t10 starts at time 30, packet[z] is dequeued, and three packet segments are reassembled into an original packet, after which the original packet is output (T111).

Since a packet, which finally remains and has the smallest output time (earliest output time) after packet[z] is output, is packet[x], t11 starts at time 57, packet[x] is dequeued, one packet segment is reassembled into an original packet, and the original packet is output, and thus the entire process is terminated (T112).

FIGS. 7A to 7D illustrate an operating process of a packet buffer with reference to the processing sequence of FIG. 6 according to an embodiment of the present disclosure.

Referring to FIG. 7A, the packet buffer block 200 may be divided into multiple memory segments 201a to 201i, and each of the memory segments may perform packet storing and outputting operations using a pointer (address).

FIG. 7A illustrates a state in which packet[k], packet[l] and packet[m] are stored in the packet buffer block 200. Assuming that the packet segments at this time are set, as shown in FIG. 6, packet segment[0] of packet[k] is stored at address 1 (202a) and packet segment[1] is stored at address 4 (202b). In the same manner, packet segment[0] of packet[l] is stored at address 6 (203). In the same manner, packet segment[0] of packet[m] is stored at address 7 (204).

Here, addresses that are not used and remain empty are in an EMPTY state (201a to 201i), and a write pointer WR_PTR for a packet to be subsequently input indicates address 0 (201a). When the above-described packet[k], packet[l], and packet[m] are stored in the packet buffer block 200, respective write pointers WR_PTR may be designated by receiving an allocation of EMPTY-state free pointers of the packet buffer block 200 from the packet buffer free pointer FIFO block 410 of the packet buffer manager block 400.

FIG. 7B illustrates a state after packet[x], packet[y], and packet[z] are additionally stored in the packet buffer block 200. Assuming that the packet segments at this time are set, as shown in FIG. 6, packet segment[0] of packet[x] is stored at address 0 (211). Packet segment[0] of packet[y] is stored at address 2 (212a), and packet segment[1] of packet[y] is stored at address 3 (212b). Packet segment[0] of packet[z] is stored at address 5 (213a), packet segment[1] of packet[z] is stored at address 8 (213b), and packet segment[2] of packet[z] is stored at address 9 (213c). Here, addresses that are not used and remain empty are in an EMPTY state, and a write pointer WR_PTR for a packet to be subsequently input indicates address 10.

When the above-described packet[x], packet[y], and packet[z] are stored in the packet buffer block 200, respective write pointers WR_PTR may be designated by receiving an allocation of EMPTY-state free pointers of the packet buffer block 200 from the packet buffer free pointer FIFO block 410 of the packet buffer manager block 400.

Referring to FIG. 7C, FIG. 7C shows the state of the packet buffer block 200 at a time point when packet[k] is output. Here, after a current time exceeds the output time of packet[k] in the priority queue manager block 500, metadata of packet[k] is output from the priority queue metadata buffer block 510, address 1 and address 4 of a read pointer RD_PTR are transferred from the metadata to the packet buffer block 200, and thus packet segment[0] 202a and packet segment[1] 202b of packet[k] are output.

It is assumed that subsequent packets are output in the order described in FIG. 6. In the same manner, after the current time exceeds the output time of packet[l] in the priority queue manager block 500, metadata of packet[l] is output from the priority queue metadata buffer block 510, and address 6 of the read pointer RD_PTR is transferred from the above-described metadata to the packet buffer block 200, and thus packet segment[0] 203 of packet[l] is output.

In the same manner, after the current time exceeds the output time of packet[m] in the priority queue manager block 500, metadata of packet[m] is output from the priority queue metadata buffer block 510, and address 7 of the read pointer RD_PTR is transferred from the above-described metadata to the packet buffer block 200, and thus packet segment[0] 204 of packet[m] is output.

In the same manner, after the current time exceeds the output time of packet[y] in the priority queue manager block 500, metadata of packet[y] is output from the priority queue metadata buffer block 510, and address 2 and address 3 of the read pointer RD_PTR are transferred from the above-described metadata to the packet buffer block 200, and thus packet segment[0] 212a and packet segment [1] 212b of packet[y] are output.

In the same manner, after the current time exceeds the output time of packet[z] in the priority queue manager block 500, metadata of packet[z] is output from the priority queue metadata buffer block 510, and address 5, address 8, and address 9 of the read pointer RD_PTR are transferred from the above-described metadata to the packet buffer block 200, and thus packet segment[0] 213a, packet segment[1] 213b, and packet segment[2] 213c of packet[z] are output.

Referring to FIG. 7D, FIG. 7D shows the state of the packet buffer block 200 at a time point when packet[x] is output. Here, assuming that previous packets have been output in the order described in FIG. 6, the time represents a state after the output of packet[k], packet[l], packet[m], packet[y], and packet[z] has been completed and all of addresses used at this time have been stored for recycling in the packet buffer free pointer FIFO block 410. Accordingly, the addresses used by previous packets of the packet buffer block 200 are in EMPTY states 220a to 220i.

Packet segment[0] of packet[x] is stored at address 0 (211), all of addresses 1 to 9 are in EMPTY states 220a, 220b, 220c, 220d, 220e, 220f, 220g, 220h, and 220i, and a write pointer WR_PTR of a packet to be subsequently input indicates address 10 (201g).

The output of packet[x] progresses in the same process as that described in FIG. 7C. Thereafter, as described above with reference to FIG. 7B, the addresses of the packet buffer block 200 used to store packet[x] may also be stored for pointer recycling in the packet buffer free pointer FIFO block 410.

FIGS. 8A and 8B illustrate an operating process of a packet buffer free pointer FIFO block according to an embodiment of the present disclosure with reference to the processing procedure of FIG. 6.

Referring to FIGS. 8A and 8B, the packet buffer free pointer FIFO block 410 may perform functions of storing the free pointers of the packet buffer block 200, allocating a requested free pointer from a head of FIFO in response to a free pointer request, adding the pointer, the use of which has been completed after the output of a packet, to a tail of the FIFO, and recycling the pointer.

The packet buffer free pointer FIFO block 410 may set pointers stored in the FIFO to initial states by performing an initialization process so as to prevent permanent loss of a specific pointer attributable to malfunctioning if necessary.

Referring to FIG. 8A, the state of the packet buffer free pointer FIFO block 410, before the above-described packet[x], packet[y] and packet[z] are stored in the packet buffer block 200, is illustrated, wherein free pointers to be allocated to the packet buffer block 200 are stored in order from the head to the tail.

When packet[x] is stored, the packet buffer input (write) control block 420 of the packet buffer manager block 400 requests one free pointer corresponding to the number of packet segments from the packet buffer free pointer FIFO block 410 at 411. The packet buffer free pointer FIFO block 410 may transfer address 0 (413a) positioned at the head of the FIFO as a free pointer at 412. After this process is performed, the head of the FIFO may be updated to address 2 (413b).

In the same manner, when packet[y] is stored, the packet buffer write control block 420 of the packet buffer manager block 400 requests two free pointers corresponding to the number of packet segments from the packet buffer free pointer FIFO block 410 at 411. The packet buffer free pointer FIFO block 410 may transfer address 2 (413b) and address 3 (413c), positioned at the head of the FIFO, as free pointers at 412. After this process is performed, the head of the FIFO may be updated to address 5 (413d).

In the same manner, when packet[z] is stored, the packet buffer write control block 420 of the packet buffer manager block 400 requests three free pointers corresponding to the number of packet segments from the packet buffer free pointer FIFO block 410 at 411. The packet buffer free pointer FIFO block 410 may transfer address 5 (413d), address 8 (413e), and address 9(413f), positioned at the head of the FIFO, as free pointers at 412. After this process is performed, the head of the FIFO may be updated to address 10 (413g).

Referring to FIG. 8B, FIG. 8B illustrates a state after the above-described packet[k], packet[l], packet[m], packet[y] and packet[z] have been output from the packet buffer block 200, and addresses used at the time of outputting have been stored for recycling in the packet buffer free pointer FIFO block 410. When the output of packet[k] from the packet buffer block 200 is completed, address 1(415b) and address 4(415c), which were used to store the above-described packet[k], are transferred for recycling to the packet buffer free pointer FIFO block 410 at 414, and stored at the tail of the FIFO. Here, at the tail of the FIFO, address 4 is stored.

It is assumed that subsequent packets are also output in the order described in FIG. 6. In the same manner, when the output of packet[l] from the packet buffer block 200 is completed, address 6 (415d) used to store packet[l] is transferred for recycling to the packet buffer free pointer FIFO block 410 at 414, and stored at the tail of the FIFO. Here, at the tail of the FIFO, address 6 is stored.

In the same manner, when the output of packet[m] from the packet buffer block 200 is completed, address 7 (415e) used to store packet[m] is transferred for recycling to the packet buffer free pointer FIFO block 410 at 414, and stored at the tail of the FIFO. Here, at the tail of the FIFO, address 7 is stored.

In the same manner, when the output of packet[y] from the packet buffer block 200 is completed, address 2 (415f) and address 3 (415g), which were used to store packet[y], are transferred for recycling to the packet buffer free pointer FIFO block 410 at 414, and stored at the tail of the FIFO. Here, at the tail of the FIFO, address 3 is stored.

In the same manner, when the output of packet[z] from the packet buffer block 200 is completed, address 5 (415h), address 8 (415i), and address 9 (415j), which were used to store packet[z], are transferred for recycling to the packet buffer free pointer FIFO block 410 at 414, and stored at the tail of the FIFO. Here, at the tail of the FIFO, address 9 is stored.

FIG. 9 illustrates an operating process of a priority queue metadata buffer block with reference to the processing sequence of FIG. 6 according to an embodiment of the present disclosure.

The priority queue metadata buffer block 510 of FIG. 9 may be divided into multiple memory segments 511 to 517, and each of the memory segments may perform packet storing and outputting operations using a pointer (address).

Referring to FIG. 9, a state in which pieces of metadata of packet[k], packet[l], packet[m], packet[x], packet[y], and packet[z] are stored in the priority queue metadata buffer block 510 is illustrated. A write pointer WR_PTR of the priority queue metadata buffer block 510 used at this time may be designated by receiving an allocation of EMPTY-state free pointers of the priority queue metadata buffer block 510 from the metadata buffer free pointer FIFO block 520.

Here, metadata of packet[k] is stored at address 19 (514), metadata of packet[l] is stored at address 20 (515), metadata of packet[m] is stored at address 21 (516), metadata of packet[x] is stored at address 0 (511), metadata of packet[y] is stored at address 1 (512), and metadata of packet[z] is stored at address 2 (513).

The foregoing pieces of metadata may be sequentially output under the control of the priority queue manager block 500. When each piece of metadata is output, the corresponding address may be returned for recycling to the metadata buffer free pointer FIFO block 520.

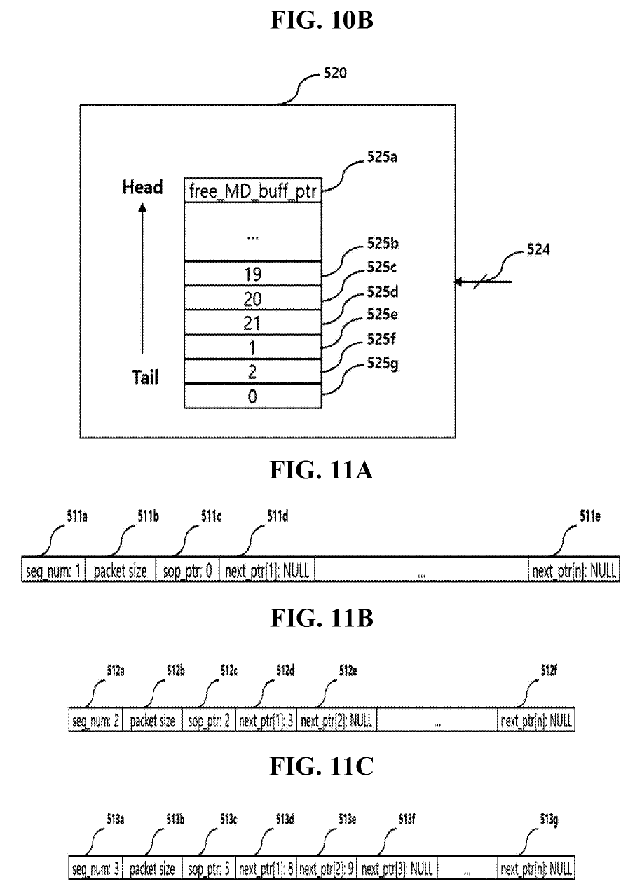

FIGS. 10A and 10B illustrate an example of an operating process of a metadata buffer free pointer FIFO block according to the present disclosure.

FIGS. 10A and 10B illustrate an example for explaining the operating process of the metadata buffer free pointer FIFO block with reference to the processing sequence of FIG. 6 according to an embodiment of the present disclosure.

Referring to FIGS. 10A and 10B, the metadata buffer free pointer FIFO block 520 may perform functions of storing the free pointers of the priority queue metadata buffer block 510, allocating a requested free pointer from a head of the FIFO in response to a free pointer request, adding the pointer, the use of which has been completed after the output of metadata, to a tail of the FIFO, and recycling the pointer. The metadata buffer free pointer FIFO block 520 may set pointers stored in the FIFO to initial states by performing an initialization process so as to prevent permanent loss of a specific pointer attributable to malfunctioning if necessary.

Referring to FIG. 10A, FIG. 10A illustrates the state of the metadata buffer free pointer FIFO block 520, before pieces of metadata of the foregoing packet[x], packet[y] and packet[z] are stored in the priority queue metadata buffer block 510, wherein free pointers to be allocated to the priority queue metadata buffer block 510 are stored in order from the head to the tail.

When the metadata of packet[x] is stored, the priority queue write control block 530 of the priority queue manager block 500 may request a free pointer from the metadata buffer free pointer FIFO block 520 at 521, and the metadata buffer free pointer FIFO block 520 may transfer address 0 (523a) positioned at the head of the FIFO as a free pointer at 522. After this process is performed, the head of the FIFO may be updated to address 1 (523b).

In the same manner, when the metadata of packet[y] is stored, the priority queue write control block 530 of the priority queue manager block 500 may request a free pointer from the metadata buffer free pointer FIFO block 520 at 521, and the metadata buffer free pointer FIFO block 520 may transfer address 1 (523b) positioned at the head of the FIFO as a free pointer in 522. After this process is performed, the head of the FIFO may be updated to address 2 (523c).

In the same manner, when the metadata of packet[z] is stored, the priority queue write control block 530 of the priority queue manager block 500 may request a free pointer from the metadata buffer free pointer FIFO block 520 at 521, and the metadata buffer free pointer FIFO block 520 may transfer address 2 (523c) positioned at the head of the FIFO as a free pointer in 522. After this process is performed, the head of the FIFO may be updated to address 3 (523d).

In FIG. 10B, a change in a FIFO state in a metadata output process may be described.

Referring to FIG. 10B, FIG. 10B illustrates a state after pieces of metadata of packet[k], packet[l], packet[m], packet[x], packet[y], and packet[z] are output from the priority queue metadata buffer block 510 and addresses used at the time of outputting are stored for recycling in the metadata buffer free pointer FIFO block 520. When the output of the metadata of packet[k] from the priority queue metadata buffer block 510 is completed, address 19 (525b) used to store the metadata of the foregoing packet[k] may be transferred for recycling to the metadata buffer free pointer FIFO block 520 at 524, and may be stored at the tail of the FIFO.

It is assumed that subsequent packets are also output in the order described in FIG. 6. In the same manner, when the output of metadata of packet[l] from the priority queue metadata buffer block 510 is completed, address 20 (525c) used to store the metadata of packet[l] may be transferred for recycling to the metadata buffer free pointer FIFO block 520 at 524, and may be stored at the tail of the FIFO.

In the same manner, when the output of metadata of packet[m] from the priority queue metadata buffer block 510 is completed, address 21 (525d) used to store the metadata of packet[m] may be transferred for recycling to the metadata buffer free pointer FIFO block 520 at 524, and may be stored at the tail of FIFO.

In the same manner, when the output of metadata of packet[y] from the priority queue metadata buffer block 510 is completed, address 1 (525e) used to store the metadata of packet[y] may be transferred for recycling to the metadata buffer free pointer FIFO block 520 at 524, and may be stored at the tail of FIFO.

In the same manner, when the output of metadata of packet[z] from the priority queue metadata buffer block 510 is completed, address 2 (525f) used to store the metadata of packet[z] may be transferred for recycling to the metadata buffer free pointer FIFO block 520 at 524, and may be stored at the tail of FIFO.

In the same manner, when the output of metadata of packet[x] from the priority queue metadata buffer block 510 is completed, address 0 (525g) used to store the metadata of packet[x] may be transferred for recycling to the metadata buffer free pointer FIFO block 520 at 524, and may be stored at the tail of FIFO.

FIGS. 11A to 11C may illustrate an embodiment of a detailed configuration of metadata for each packet.

FIGS. 11A to 11C illustrate a detailed configuration of metadata for each packet;

Pieces of metadata configured in FIGS. 11A to 11C are simply configured for convenience of description, and various configurations may be enabled as needed in an actual implementation. Further, the number of packet segments and the address pointers of the packet segments may vary depending on the size of memory segments set in the packet buffer block 200.

FIG. 11A shows the metadata of packet[x]. Assuming that packet[x] is set, as described above with reference to FIG. 6, the metadata of packet[x] may be composed of the number of packet segments: 1 (511a), a packet size (length) (511b), and the address pointer of a packet buffer block: 0 (511c) storing a first packet segment. In this case, because the number of packet segments is 1, all address pointers 511d and 511e subsequent to the first packet segment may be set to NULL.

FIGS. 11B and 11C may illustrate detailed configurations of pieces of metadata of packet[y] and packet[z], respectively.

Referring to FIG. 11B, FIG. 11B illustrates the metadata of packet[y]. Assuming that packet[y] is set, as described above with reference to FIG. 6, the metadata of packet[y] may be composed of the number of packet segments: 2(512a), a packet size (length) (512b), the address pointer: 2 (512c) of a packet buffer block storing a first packet segment, and the address pointer: 3 (512d) of a packet buffer block storing a second packet segment. In this case, because the number of packet segments is 2, all address pointers 512e and 512f subsequent to the first and second packet segments may be set to NULL.

Referring to FIG. 11C, FIG. 11C may illustrate a detailed configuration of metadata of packet[z].

FIG. 11C shows the metadata of packet[z]. Assuming that packet[z] is set, as described above with reference to FIG. 6, the metadata of packet[z] may be composed of the number of packet segments: 3 (513a), a packet size (length) (513b), the address pointer of a packet buffer block: 5 (513c) storing a first packet segment, the address pointer of a packet buffer block: 8 (513d) storing a second packet segment, and the address pointer: 9 (513e) of a packet buffer block storing a third packet segment. In this case, because the number of packet segments is 3, all address pointers 513f and 513g subsequent to the first, second, and third packet segments may be set to NULL.

FIGS. 12A to 12C may illustrate an embodiment of an operating process of a priority queue block according to the present disclosure.

FIGS. 12A to 12C illustrate an example of an operating process of the priority queue block 800 according to an embodiment of the present disclosure.

FIGS. 12A to 12C may illustrate simple examples for explaining entry contents of a priority queue after complication of sorting based on priority in a state where an enqueue process or a dequeue process of one packet has been terminated in the binary heap-based priority queue block 800. The foregoing priority queue block 800 may store the addresses (pointers) of the priority queue metadata buffer block 510 in which output times and metadata of respective packets are stored, and may be maintained such that, by setting the output times of respective packets as the reference of priorities, a packet having the smallest output time (earliest output time) is positioned at a first entry.

Referring to FIG. 12A, FIG. 12A illustrates a state in which packet priorities are sorted based on the output times of respective packet[k], packet[l] and packet[m] after the enqueue process of the packets in the priority queue block 800 has been terminated. Assuming that the output times of packet[k], packet[l] and packet[m] are set as described above with reference to FIG. 6, the output time t6(20) of packet[k] is earlier than the output times t7(24) and t8(25) of other packets, that is, packet[l] and packet[m], and thus packet[k] is positioned at a first entry 801. Because the output time t7(24) of packet[l] is earlier than the output time t8(25) of packet[m], packet[l] may be positioned at a second entry 802, and packet[m] having a latest output time may be positioned at a third entry 803.

FIG. 12B may illustrate the state of the priority queue block after an enqueue process of additional packets is terminated.

Referring to FIG. 12B, FIG. 12B illustrates a state in which packet priorities are sorted based on the output times of packet[x], packet[y] and packet[z] after the enqueue process of the packets in the priority queue block 800 has been terminated. It is assumed that the output times of packet[x], packet[y] and packet[z] are set, as described above with reference to FIG. 6. In a state in which packet[x] is first enqueued and packet[y] is subsequently enqueued, the output time t9(28) of the subsequently-enqueued packet[y] is earlier than the output time t11(57) of the previously-enqueued packet[x], and thus packet[y] may be positioned at a fourth entry 814.

When packet[z] is enqueued in the same manner, the output time t10(30) of packet[z] is earlier than the output time t11(57) of packet[x], and thus packet[z] may be positioned at a fifth entry 815, and packet[x] having the latest output time may be positioned at a sixth entry 816. Referring to the description of FIG. 6, even at a time point t5(10) when the last packet[z] is enqueued, the output time t6(20) of the first entry, that is, packet[k], is earlier than the current time, and thus a dequeue process may not occur.

FIG. 12C may illustrate the state of the priority queue block after the dequeue process of packets is completed.

Referring to FIG. 12C, FIG. 12C illustrates the state of the priority queue after the dequeue processes of packet[k], packet[l], packet[m], packet[y], and packet[z] have been terminated, wherein only packet[x] may remain at a first entry 821.

FIG. 13 illustrates an example of connection states between the priority queue block 800, the priority queue metadata buffer block 510, and the packet buffer block 200 according to an embodiment of the present disclosure.

Referring to FIG. 13, the above-described priority queue block 800 stores the output times of packets and priority queue metadata buffer pointers in order from a first entry in ascending order of packet output times, as described above with reference to FIG. 12. As described with reference to FIG. 9, the priority queue metadata buffer block 510 stores pieces of metadata of packets. As described with reference to FIG. 7, the packet buffer block 200 may store each packet in units of packet segments.

In detail, assuming that a reception and transmission process of packets is set, as described with reference to FIG. 6, at a first entry of the priority queue block 800, the output time (time 20) of packet[k] having the earliest output time, and a priority queue metadata buffer pointer (address 19) are stored (811). Thereafter, at second, third, and fourth entries, output times and priority queue metadata buffer pointers may be respectively stored in ascending order of output times (812, 813, and 814).

At address 19 of the priority queue metadata buffer block 510, metadata of packet[k] is stored (514), and the above-described metadata may include information such as the number of packet segments of packet[k], a packet size, and packet segment pointers stored in the packet buffer. Packet segment[0] and packet segment[1] of the above-described packet[k] may be respectively stored at address 1 and address 4 of the packet buffer block 200 (202a and 202b).

When the current time exceeds the output time (time 20) of packet[k], stored at the first entry of the priority queue block 800, metadata of packet[k] is read from the priority queue metadata buffer block 510 using the priority queue metadata buffer pointer (address 19) of packet[k], after which packet[k] may be output from the packet buffer block 200 using the pointer of packet segment[0] and the pointer of packet segment[1], which are extracted from the foregoing metadata.

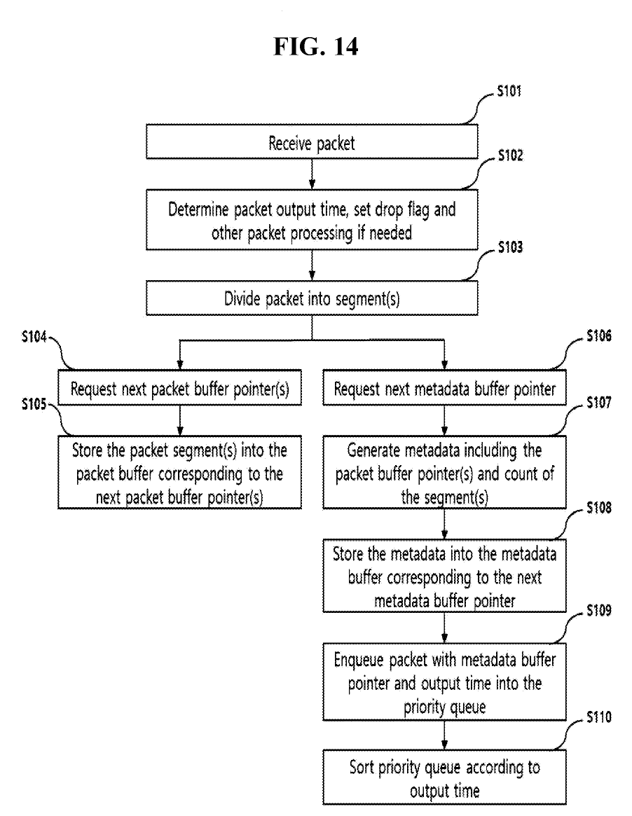

FIG. 14 illustrates an example of a packet enqueue process according to the present disclosure.

FIG. 14 is a flowchart for explaining an enqueue process of a high-speed priority queue management method capable of per-node delay control according to an embodiment of the present disclosure.

Referring to FIG. 14, when a packet is received at step S101, the process may proceed to step S102.

At step S102, a packet processing procedure for transferring the packet to a destination may be performed, the output time of the packet may be determined, and procedures such as filtering, policing, and shaping may be additionally performed. Further, when the packet needs to be discarded (dropped) for a specific reason, a flag for dropping the packet may be set. Thereafter, the process may proceed to step S103.

At step S103, the packet may be divided into packet segment(s) according to a memory segment size. When the length of the input packet does not exceed a memory segment size, a division process may be skipped. On the other hand, when the length of the input packet exceeds the memory segment size, the packet may be divided into multiple packet segments corresponding to the length of the input packet so that multiple memory segments are allocated and the input packet is stored in the memory segments. Thereafter, the process may proceed to steps S104 and S106.

At step S104, in order to store packet segments in the packet buffer block 200, a packet buffer free pointer may be requested from the packet buffer free pointer FIFO block 410 in the packet buffer manager block 400. Here, when a single packet is divided into multiple packet segments, a number of packet buffer free pointers corresponding to the number of packet segments may be requested. Thereafter, the process may proceed to step S105.

At step S105, the packet segments may be stored in the packet buffer block 200 based on the packet buffer free pointers.

At step S106, in order to store the metadata of the packet in the priority queue metadata buffer block 510, a metadata buffer free pointer may be requested from the metadata buffer free pointer FIFO block 520 in the priority queue manager block 500. Thereafter, the process may proceed to step S107.

At step S107, metadata including the number (count) of packet buffer free pointers, a packet size, packet buffer free pointers may be generated. Thereafter, the process may proceed to step S108.

At step S108, the metadata may be stored in the priority queue metadata buffer block 510 according to the metadata buffer free pointer. Thereafter, the process may proceed to step S109.

At step S109, the priority queue metadata buffer pointer and the output time may be stored (enqueued) into the priority queue block 800. Thereafter, the process may proceed to step S110.

At step S110, the priority queue may be sorted based on the earliest output time, and the enqueue process may be completed.

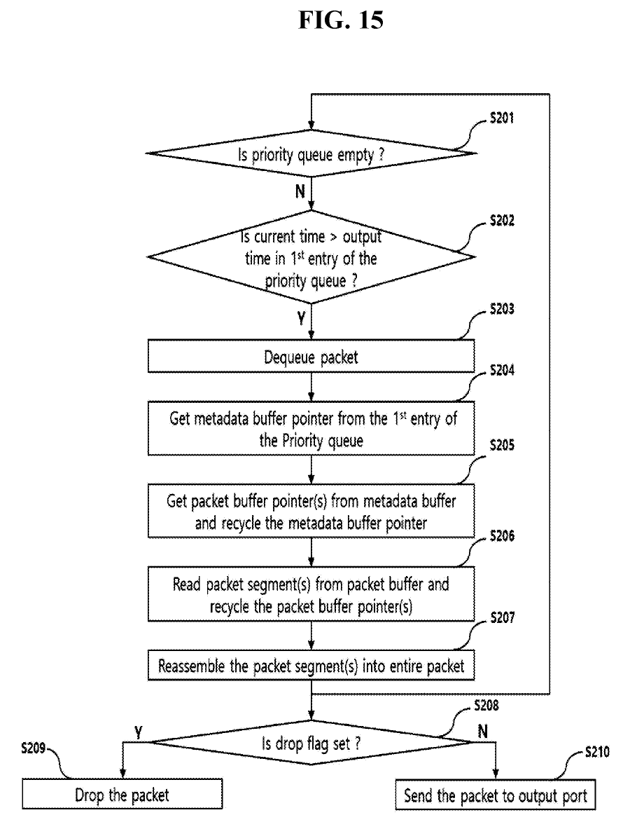

FIG. 15 illustrates an example of a packet dequeue process according to the present disclosure.

Referring to FIG. 15, whether an entry is present in the priority queue block 800 is checked at step S201. When the entry is present, the process may proceed to step S202, whereas when an entry is in an EMPTY state, the process may remain at step S201.

At step S202, the current time is compared with the output time of the first entry of the priority queue block 800. When the current time exceeds the output time, the process may proceed to step S203, whereas when the current time does not exceed the output time, the process may remain in the state at step S202.

At step S203, a first entry may be dequeued from the priority queue block 800. After the first entry is dequeued, the priority queue block 800 may reorder the priority queue based on the earliest output time among the remaining entries. Thereafter, the process may proceed to step S204.

At step S204, priority queue metadata buffer pointer(s) may be obtained from the dequeued first entry of the priority queue block 800, and the process may proceed to step S205.

At step S205, metadata may be output from the priority queue metadata buffer block 510 using the priority queue metadata buffer pointer(s), and the packet buffer pointer(s) may be obtained from the metadata. The priority queue metadata buffer pointer(s) used to output the metadata from the priority queue metadata buffer block 510 may be transferred for recycling to the metadata buffer free pointer FIFO block 520. Thereafter, the process may proceed to step S206.

At step S206, packet segment(s) may be read from the packet buffer block 200 using packet buffer pointer(s). The packet buffer pointer(s) used to read the packet segment(s) from the packet buffer block 200 may be transferred for recycling to the packet buffer free pointer FIFO block 410. Thereafter, the process may proceed to step S207.

At step S207, when a single packet is divided into one or more packet segments, the read packet segments may be reassembled into the entire packet. Thereafter, the process may proceed to step S208 and return to step S201.

At step S208, whether a packet discard (drop) flag is set is checked. When the packet drop flag is set, the process may proceed to step S209, otherwise the process may proceed to step S210.

At step S209, the packet may be dropped, and the dequeue process may be terminated.

At step S210, the packet may be sent to the output port, and the dequeue process may be terminated.

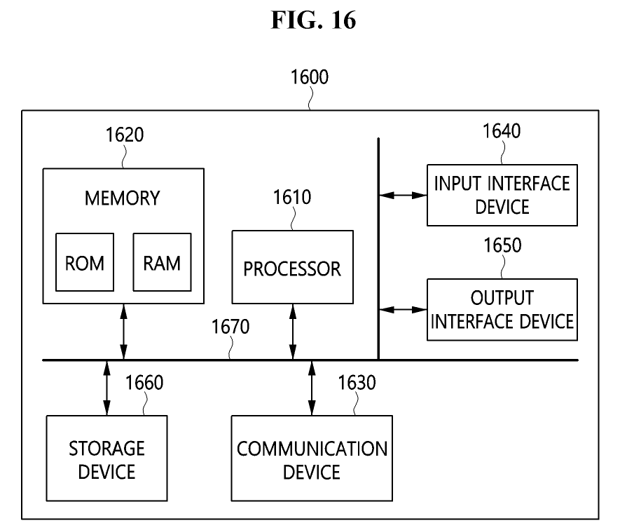

FIG. 16 illustrates the configuration of a high-speed priority queue management apparatus capable of per-node delay control according to an embodiment of the present disclosure.

Referring to FIG. 16, the high-speed priority queue management apparatus capable of per-node delay control (hereinafter also referred to as “apparatus”) may include at least one processor 1610, memory 1620, and a communication device 1630 connected to a network to perform communication. The apparatus may further include an input interface device 1640, an output interface device 1650, a storage device 1660, and the like. Individual components included in the apparatus may be connected through a bus 1670 to communicate with each other.

The components included in the apparatus may also be connected to each other through individual interfaces or individual buses based on the processor 1610, rather than through the common bus 1670. For example, the processor 1610 may be connected to at least one of the memory 1620, the communication device 1630, the input interface device 1640, the output interface device 1650 or the storage device 1660, or a combination thereof through a dedicated interface.

The processor 1610 may execute program commands stored in at least one of the memory 1620 or the storage device 1660, or a combination thereof. The processor 1610 may refer to a central processing unit (CPU), a graphics processing unit (GPU), or a dedicated processor on which methods according to embodiments of the present disclosure are performed. Each of the memory 1620 and the storage device 1660 may be implemented as at least one of a volatile storage medium or a nonvolatile storage medium, or a combination thereof. For example, the memory 1620 may be implemented as at least one of read only memory (ROM) or random access memory (RAM), or a combination thereof.

The methods according to embodiments described in the claims or the specification of the present disclosure may be implemented in the form of hardware, software, or a combination of hardware and software.

When each method is implemented as software, a computer-readable storage medium storing one or more programs (software modules) may be provided. One or more programs stored in the computer-readable storage medium may be configured for execution by one or more processors in an electronic device. One or more programs include instructions that cause the electronic device to execute the methods according to embodiments described in the claims or the specification of the present disclosure.

Such programs (software modules or software) may be stored in random access memory (RAM), nonvolatile memory including flash memory, read-only memory (ROM), electrically erasable programmable read-only memory (EEPROM), magnetic disk storage devices, compact disc read-only memory (CD-ROM), digital versatile discs (DVDs), or other types of optical storage devices or magnetic cassettes. Further, they may be stored in a memory configured by a combination of some or all thereof. In addition, each of the constituent memories may be provided in plurality.

Further, the programs may be stored in an attachable storage device accessible through a communication network such as the Internet, an intranet, a local area network (LAN), a wide area network (WAN), or a storage area network (SAN), or a communication network formed by a combination thereof. Such a storage device may be connected to an apparatus performing embodiments of the present disclosure through an external port. In addition, a separate storage device on the communication network may be connected to an apparatus performing embodiments of the present disclosure.

In the specific embodiments of the present disclosure described above, components included in the disclosure are expressed in singular or plural form according to the presented specific embodiments. However, the singular or plural expressions are selected appropriately for convenience of description, and the present disclosure is not limited to singular or plural components. Even when a component is expressed in plural form, it may be configured as a singular component, and even when a component is expressed in singular form, it may be configured as a plurality of components.

The apparatus and method according to various embodiments of the present disclosure can provide a high-precision end-to-end on-time service by controlling the output times of packets for respective nodes.

Further, the apparatus and method according to various embodiments of the present disclosure can accurately output packets at determined output times through a binary-heap-based sorted priority queue and efficient free pointer management of a packet buffer.

Furthermore, the apparatus and method according to various embodiments of the present disclosure can optimize memory use through efficient storage and management of packet segments.

Furthermore, the apparatus and method according to various embodiments of the present disclosure enable high-speed packet input/output through packet processing using metadata.

Furthermore, the apparatus and method according to various embodiments of the present disclosure can efficiently process variable-length packets through a linked list-based packet buffer.

Furthermore, the apparatus and method according to various embodiments of the present disclosure can decrease complexity of system implementation through a priority queue metadata buffer.

The effects of the present disclosure are not limited to the above-mentioned effects, and those skilled in this art to which the present disclosure pertains will be able to easily understand other unmentioned effects from the following description.

Meanwhile, although the detailed description of the present disclosure has been described with reference to specific embodiments, it is apparent that various modifications may be made without departing from the scope of the present disclosure. Accordingly, the scope of the present disclosure should not be limited to the described embodiments but should be defined by the appended claims and equivalents thereof.

What is claimed is:

1. A high-speed priority queue management method capable of per-node delay control, comprising:
receiving packets and determining output times of the packets based on node budget profiles;
dividing each packet into one or more packet segments according to a memory segment size;
receiving an allocation of a number of free pointers corresponding to a number of packet segments from a packet buffer free pointer First-In First-Out (FIFO), and storing the packet segments in a packet buffer;
receiving an allocation of free pointers from a metadata buffer free pointer FIFO, and storing, in a priority queue metadata buffer, metadata including a number of memory segments for the corresponding packet, a packet length, and a memory segment pointer;
storing output times of the packets and pointers of a metadata buffer in which the metadata is stored in a binary heap-based priority queue, and sorting the pointers in order of the output times; and
when a system time exceeds an output time stored at a top entry of the priority queue, outputting the corresponding packet.

2. The high-speed priority queue management method of claim 1, wherein an output time of each packet is determined to be a sum of a corresponding packet reception time and a delay time set for a node budget profile.

3. The high-speed priority queue management method of claim 1, wherein delay times of the node budget profiles are set on a per-packet basis, a per-flow basis, a per-flow-group basis, or a per-class basis, and the delay times are set in consideration of link delay, node processing delay, and node queuing delay.

4. The high-speed priority queue management method of claim 1, wherein each of the packet buffer free pointer FIFO and the metadata buffer free pointer FIFO stores available memory pointers in a direction from a head to a tail, allocates a pointer from the head in response to a pointer request, and adds a pointer, use of which has been completed, to the tail when packet output is completed.

5. The high-speed priority queue management method of claim 1, wherein the metadata includes a number of packet segments, a packet length, an address pointer of a first packet segment, and address pointers of subsequent packet segments.

6. The high-speed priority queue management method of claim 1, wherein the binary heap-based priority queue maintains sorting such that a packet having an earliest output time is positioned at a top entry, and updates a sorted state in enqueue and dequeue operations.

7. The high-speed priority queue management method of claim 1, wherein the system time is synchronized through IEEE 1588v2 protocol, and an output time point of each packet is determined based on the synchronized system time.

8. The high-speed priority queue management method of claim 1, wherein the packet segments are stored in memory regions of the packet buffer according to addresses designated by the packet buffer free pointers, and the metadata is stored in memory regions of the metadata buffer according to addresses designated by the metadata buffer free pointers.

9. The high-speed priority queue management method of claim 1, wherein after completion of output of the packets, memory pointers, use of which has been completed, are returned to respective free pointer FIFOs and recycled.

10. The high-speed priority queue management method of claim 1, wherein, upon outputting packets, the metadata is read from a priority queue metadata buffer, and packet segments are sequentially output from the packet buffer using pointers included in the metadata.

11. A high-speed priority queue management apparatus capable of per-node delay control, comprising:
an input port configured to receive packets;
a packet processor configured to determine output times of the packets,
a packet buffer configured to store each packet in units of memory segments;
a packet buffer free pointer First-In First-Out (FIFO) configured to manage pointers of available memory segments;
a priority queue metadata buffer configured to store metadata of the packets;
a metadata buffer free pointer FIFO configured to manage available metadata buffer pointers;
a binary heap-based priority queue configured to store the output times of the packets and metadata buffer pointers and perform sorting in an order of output times;
a time synchronizer configured to provide system time information;
a node budget profile configured to manage delay time information used to determine the output times of the respective packets; and
an output port configured to output the packets.

12. The high-speed priority queue management apparatus of claim 11, wherein the packet processor is configured to determine an output time of each packet to be a sum of a corresponding packet reception time and a delay time set for the node budget profile.

13. The high-speed priority queue management apparatus of claim 11, wherein the node budget profile sets the delay times on a per-packet basis, a per-flow basis, a per-flow group basis, or a per-class basis, wherein the delay times are set in consideration of link delay, node processing delay, and node queuing delay.

14. The high-speed priority queue management apparatus of claim 11, wherein each of the packet buffer free pointer FIFO and the metadata buffer free pointer FIFO stores available memory pointers in a direction from a head to a tail, allocates a pointer from the head in response to a pointer request, and adds a pointer, use of which has been completed, to the tail when packet output is completed.

15. The high-speed priority queue management apparatus of claim 11, wherein the priority queue metadata buffer stores metadata including a number of packet segments, a packet length, an address pointer of a first packet segment, and address pointers of subsequent packet segments.

16. The high-speed priority queue management apparatus of claim 11, wherein the binary heap-based priority queue maintains sorting such that a packet having an earliest output time is positioned at a top entry, and updates a sorted state in enqueue and dequeue operations.

17. The high-speed priority queue management apparatus of claim 11, wherein the time synchronizer synchronizes system time through an IEEE 1588v2 protocol and determines an output time point of each packet based on the synchronized system time.

18. The high-speed priority queue management apparatus of claim 11, wherein the packet segments are stored in memory regions of the packet buffer according to addresses designated by the packet buffer free pointers, and the metadata is stored in memory regions of the metadata buffer according to addresses designated by the metadata buffer free pointers.

19. The high-speed priority queue management apparatus of claim 11, wherein the packet buffer free pointer FIFO manages memory pointers, use of which has been completed after completion of packet output, for recycling.

20. The high-speed priority queue management apparatus of claim 11, wherein the priority queue performs control to read metadata from the priority queue metadata buffer and to sequentially output packet segments from the packet buffer using pointers included in the metadata.
